(19) United States
(12) Patent Application Publication
(10) Pub. No.: US 2004/0241869 A1
(43) Pub. Date: Dec. 2, 2004

(54) Electro thermometric method and apparatus

(76) Inventors: Gary Christopher Davies, Harlow (GB); Roger Stuart Hutton, Harlow (GB); Anthony Patrick Jones, Ware (GB)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/492,455

(22) PCT Filed: Oct. 2, 2002
(86) PCT No.: PCT/EP02/11057

(30) Foreign Application Priority Data
Oct. 19, 2001 (GB) 0125144.6

(51) Int. Cl. B01L 3/00

(52) U.S. Cl. 436/147; 422/82.12; 422/99

(57) ABSTRACT

A method of screening a test agent for its ability to cause a thermodynamic change in a cell-free sample, comprising the steps of: i) measuring the temperature of said sample using electrothermometry; ii) contacting the sample with said test agent; iii) measuring the temperature of the sample resulting from step (ii) using electrothermometry; and iv) comparing the temperature obtained in step (i) with the temperature obtained in step (iii), wherein temperature measurement steps (i) and (iii) are conducted using a non-invasive electro thermometric method.

### TECHNICAL FIELD

The present invention relates, in general, to thermometry and, in particular, to a method of using electro thermometry to monitor temperature changes in chemical and biochemical reactions. The present method can be used for screening, identifying, and ranking drug candidates for multiple diseases, disorders and conditions. The method can also be used to rank thermodynamic and kinetic responses of chemical and biochemical reactions.

### BACKGROUND TO THE INVENTION

Thermodynamics is a science concerned with relations between work and heat. Virtually every chemical reaction or physiological process in animals or cells occurs with the absorption or generation of heat and thus, any heat absorbed or generated by a system is related to the amount of work done. Measurement of heat output (i.e., thermo genesis) can be used to estimate the energy used in or produced by chemical reactions and physiological processes. Consequently, methods which can accurately and precisely measure minute changes in temperature resulting from chemical and biochemical reactions have broad utility in pharmaceutical and chemical research and development.

In the field of biochemistry, various methods are available for measuring thermal changes at both the cellular and sub-cellular level. However, although a range of methods (e.g., Northern or Western-blotting) are available for detecting the expression of proteins that regulate thermo genesis in cells (e.g., uncoupling proteins, UCPs), these methods are labour intensive and do not directly measure protein activity. Guanosine 5′-diphosphate (GDP)-binding assays and fluorescent dyes (e.g., JC-1 or rhodamine derivatives) provide a direct measure of UCP activity (Nedergaard and Cannon, Am. J. Physiol. 248(3 Pt 1):C365-C371 (1985); (Reers et al, Biochemistry 30:4480-4486 (1991)). However, GDP-binding assays require protein purification and use of dyes is limited because of non-selective staining, cytotoxicity, and metabolism of the dyes by cells. More importantly, all of these techniques fail to directly measure real-time fluctuations in thermogenesis and are invasive.

Bomb calorimeters and microcalorimeters provide a means for quantitatively measuring the heat generated or consumed by cultured cells (Bottcher and Furst, J. Biochem. Biophys. Methods 32: 191-194 (1996)) or chemical reactions. However, despite recent progress in developing multichannel calorimeters, methods for rapidly analysing changes in heat in multiple simultaneous reactions (≧60) are not available.

Recently, infrared thermographic techniques have been described (WO 99/60630) that provide a rapid non-invasive method of measuring real-time thermogenesis in animals, plants, tissues and isolated cells. This method, which is based on the use of infrared thermography, can also be used to screen and identify drug candidates for treating various diseases, disorders and conditions. While this is a relatively sensitive and versatile technique, it has the potential drawback of requiring specialized and costly equipment such as an infrared imaging system.

The ability of thermistors to accurately monitor temperature changes resulting from chemical reactions has also been demonstrated. Thus Danielsson et al. (Analyst, 120, 155-160 (1995)) have used thermistors to measure temperature changes downstream of an immobilized enzyme in a continuous flow of substrate. More recently, Connolly & Sutherland (Agnew. Chem. 112, 4438-4441 (2000)) have reported that a multiplexed array of thermistors can be used to monitor temperature change for chemical and biochemical catalyst screening. While this technique is extremely sensitive, reliably detecting 100 μK changes, it is invasive in nature and necessitates the immersion of thermistors within the assay solutions undergoing biochemical or chemical reaction. The introduction of a foreign body, such as a thermistor, into the test solutions may contaminate or alter the thermodynamics of the system under scrutiny and lead to artefacts in the data obtained.

The present invention provides a non-invasive means to reliably and sensitively measure temperature changes resulting from chemical or biochemical reactions using electro thermometry, in particular using resistance thermometry. The present invention can be used to analyse the effects of various agents on heat production in a variety of cells and cell-free systems, including enzyme catalysis, and, more generally, during ligand interaction with a binding partner. The invention makes it possible to screen compounds for their ability to alter heat dissipation, and to identify compounds that have application in the treatment of various diseases, disorder and conditions, including those involving altered thermogenic responses in in-vitro and in in-vivo applications.

The present invention, in developments, also makes it possible to integrate electronic sensing into a standard well-plate test apparatus, thereby enhancing standard handling methods. Electronic interfaces, including those making use of telemetry, may also be incorporated.

### SUMMARY OF THE INVENTION

According to one aspect of the present invention there is provided a method of screening a test agent for its ability to cause a thermodynamic change in a cell-free sample, comprising:

(i) measuring the temperature of said sample;

(ii) contacting said sample with said test agent;

(iii) measuring the temperature of said sample resulting from step (ii); and

(iv) comparing the temperature obtained in step (i) with the temperature obtained in step (iii),

wherein temperature measurement steps (i) and (iii) are conducted using a non-invasive electro thermometric method.

By ‘non-invasive’ it is meant herein that the sample is not invaded or disturbed (e.g. through direct contact) by any measuring device.

Suitable electro thermometric methods rely on the use of electro thermometric apparatus (i.e. an electro thermometer) and include the use of resistance thermometry, thermocouples, thermopiles, bolometers and semiconductor devices. Bolometers record thermal radiation, as opposed to conductive heat transfer.

A difference in temperature between that obtained in step (i) and that obtained in step (iii) indicates that said test agent causes a thermodynamic change in said sample.

The method herein is suitable for monitoring thermodynamic effects in a range of chemical, biochemical and biological reaction processes.

Suitable chemistry applications include analytical applications; organic synthesis applications; organometallic synthesis applications; inorganic synthesis applications. Specific examples include the screening of heterogeneous catalysts; the screening of asymmetric catalysts; the enzymatic resolution of amines and alcohols; and the screening of enantioselective reactions.

Specific applications include high throughput screening of chemical reactions based on thermodynamic and kinetic responses. Reactions may be typical of those used in combinatorial chemistry such as Diels Alder and Ugi reactions. The method herein may also be used for optimisation of chemical reactions and processes such as crystallization, ligand binding and polymorph formation.

Suitably, the sample comprises an organic or an inorganic compound.

In one aspect, the organic compound is selected from the group consisting of protein, carbohydrate, lipid or nucleic acid. Suitably, the organic compound is a protein such as an enzyme, or a receptor.

In another aspect, when the test agent binds the organic compound, a thermodynamic change in the sample results.

In one aspect, the sample resulting from step (iii) contains both members of a binding pair. More preferably, the binding pair comprises an enzyme and a substrate therefor or a receptor and a ligand therefor.

In a further aspect, when the test agent inhibits or promotes binding of the members of the binding pair, a difference in temperature between that obtained in step (i) and that obtained in step (iii) results, as compared to a test agent-free control (or control with known response) wherein the members of the binding pair bind to each other.

In one aspect, step (iii) comprises measuring the temperature of the sample resulting from step (ii) at a multiplicity of time points, step (iv) comprises comparing the temperature obtained in step (i) with the temperature obtained in step (iii) at each of the time points, wherein a difference in temperature between that obtained in step (i) and that obtained in step (iii) at least one of the time points indicates that the test agent causes a thermodynamic change in the sample.

Preferably, the measuring of steps (i) and (iii) is effected using a resistance thermometer (or “resistance temperature detector”) that has a defined resistance at a defined temperature. More preferably, the resistance thermometer comprises a platinum resistor that has a resistance of either 100 ohms or 1000 ohms at a temperature of 0° C. (i.e. a Pt100 or Pt1000 resistor).

Platinum resistance thermometers offer high accuracy and resolution over a wide temperature range. Platinum sensors are available from many manufacturers with various accuracy specifications and numerous packaging options. Preferred sensors are surface mount units, selected for their small size and low heat capacity.

The principle of operation is to measure the resistance of a metal (e.g. platinum) element. For precision measurement, it is necessary to calibrate the resistance against temperature. That is to say, the temperature can be calculated using standard equations that relate temperature and resistance. For a Pt1000 resistor or sensor, a 1° C. temperature change will cause about a 3.84 ohm change in resistance, so even a small error in measurement of the resistance can cause a large error in measurement of the temperature. For precision work, sensors have four wires—two to carry the test current and two to measure the voltage across the sensor element.

Suitably, the resistors are balanced before use to ensure greater sensitivity of measurement.

Suitably, the method herein is conducted under controlled environmental conditions, specifically isothermal conditions. This may best be achieved using an environmental chamber to maintain constant temperature and minimise environmental variation.

In one aspect, there is provided a method of screening a test agent for its ability to cause a thermodynamic change in a sample of cells in vitro.

In one aspect, the cells are cultured cells. Suitably, the cells are eucaryotic cells such as mammalian cells (e.g. tumour cells or adipocytes).

In another, the cells are plant cells.

In another aspect, the cells are procaryotic cells.

Cells that can be monitored in accordance with the invention include isolated naturally occurring cells (including primary cultures and established cell lines) and engineered cells (e.g., isolated engineered cells). The cells can be in suspension or attached to a solid support either as a monolayer or in multilayers. Examples of suitable supports include plastic or glass plates, dishes or slides, membranes and filters, flasks, tubes, beads and other related receptacles.

Advantageously, plastic multiwell plates are used, 96-well and 384-well microtiter plates being preferred. While preferred cell titres range between 100 to 100,000 cells/cm² for adherent cells and 100 to 1,000 cells/μl in the case of suspension cultures, potentially any cell number/concentration can be used.

Isolated naturally occurring cells that can be monitored in accordance with the present method include eucaryotic cells, preferably mammalian cells. Primary cultures and established cell lines and hybridomas (such as those available from the American Type Culture Collection) can be used. Specific examples include cells or tissues derived from fat (e.g., adipocytes and precursors thereof), muscle (e.g., myotubes, myoblasts, myocytes), liver (e.g., hepatocytes, Kupffer cells), the digestive system (e.g., intestinal epithelial, salivary glands), pancreas (e.g., αand β-cells), bone marrow (e.g., osteoblasts, osteoclasts, and precursors thereof), blood (e.g., lymphocytes, fibroblasts, reticulocytes, hematopoietic progenitors), skin (e.g., keratinocytes, melanocytes), amniotic fluid or placenta (e.g., chorionic villi), tumors (e.g., carcinomas, sarcomas, lymphomas, leukemias), brain (e.g., neurons, hypothalamus, adrenal and pituitary gland), the respiratory system (e.g., lung, trachea), connective tissue (e.g., chondrocytes), eye, kidney, heart, bladder, spleen, thymus, gonads, thyroid and other organs involved in endocrine regulation. There are no restrictions on the cell types that can be used. The present method is applicable to cells derived from plants, fungi, protozoans, and the monera kingdom (e.g., bacteria). The cells can be cultured using established culture techniques and culture conditions can be optimized to ensure viability, growth and/or differentiation, as appropriate.

In a further aspect, the cells are engineered to contain a nucleic acid sequence encoding a heterologous protein or engineered to overexpress a protein endogenous to the cells.

Engineered cells that can be monitored in accordance with the present method include cells engineered to produce or overproduce proteins involved directly or indirectly in temperature regulation, energy balance and fuel utilization, growth and differentiation and other aspects of physiology or metabolism that alter heat generated by cells. Such cells can be engineered prokaryotic cells (kingdom monera: e.g., E. coli), engineered higher or lower eucaryotic cells, or cells present in or isolated from transgenic animals. Examples of higher eucaryotic cells (e.g., from the plant and animal kingdoms) include cell-lines available from the American Type Culture Collection (e.g., CV-1, COS-2, C3H10T1/2, HeLa, and SF9). Examples of lower eucaryotic cells include fungi (e.g., yeast) and protozoans (e.g., slime molds and ciliates). The cells or transgenic animals can be engineered to express any of a variety of proteins, including but not limited to nuclear receptors and transcription factors (e.g., retinoid receptors, PPARs, CCAAT-Enhancer-Binding Proteins (CEBPs), polymerases), cell surface receptors (e.g., transmembrane and non-transmembrane receptors, G protein-coupled receptors, kinase-coupled receptors), membrane transporters and channels (e.g., uncoupling proteins, sugar transporters, ion channels), signal transduction proteins, (e.g., phosphodiesterases, cyclases, kinases, phosphatases), and viruses (e.g., AIDS, herpes, hepatitis, adeno). Engineered cells can be produced by introducing a construct comprising a sequence encoding the protein to be expressed and an operably linked promoter into a selected host. Appropriate vectors and promoters can be selected based on the desired host and introduction of the construct into the host can be effected using any of a variety of standard transfection/transformation protocols (see Molecular Biology, A Laboratory Manual, second edition, J. Sambrook, E. F. Fritsch and T. Maniatis, Cold Spring Harbor Press, 1989). Cells thus produced can be cultured using established culture techniques and culture conditions can be optimized to ensure expression of the introduced protein-coding sequence.

The present method can be used to identify, characterize, rank, and select agents (e.g., drugs or drug candidates) suitable for use in treating various diseases, disorders or conditions based on potency, selectivity, efficacy, pharmacokinetics and pharmacodynamics of the agent in various cell-free and cell- based thermogenesis assays. For example, a test agent can be screened using electro thermometry for its potential as a catabolic or anabolic drug. Cultured cells (e.g., primary cells, such as adipocytes or yeast, or cell-lines, such as C3H10T1/2 mesenchymal stem cells, osteoblasts, or adipocytes) can be treated with the test agent followed by electro thermometry to measure changes in heat signature. Agents that enhance thermogenesis (cellular heat production) are potentially useful as catabolic drugs and agents that suppress thermogenesis are potentially useful as anabolic drugs.

In addition to changes in metabolism, alterations in thermogenesis can reflect changes in growth and differentiation. Thus, the present method can be used to identify, characterize, rank, and select agents (e.g., drugs or drug candidates) suitable for use in treating or preventing diseases, disorder or conditions associated with changes in metabolism, toxicity, cellular growth, organ development, and/or differentiation.

Examples of pathophysiologies potentially amenable to treatment with anabolic agents identified with electro thermometry include anorexia, alopecia, auto-immunity, cachexia, cancer, catabolism associated with aging, diabetes, graft rejection, growth retardation, osteoporosis, pyrexia, bacterial and viral infections. Examples of diseases, disorders or conditions potentially amenable to treatment with catabolic agents identified with electro thermometry include diseases, disorders or conditions associated with obesity (e.g., hypertension, dyslipidemias, and cardiovascular diseases) and diseases, disorders or conditions associated with accelerated growth (e.g., cancer, gigantism, certain viral infections). The pathophysiologies amenable to treatment using agents identified with electro thermometry are not limited to those commonly associated with changes in anabolism or catabolism (e.g., metabolic diseases). The approach is also applicable to other diseases, disorders and conditions including male erectile dysfunction (MED), inflammation, hypertension, gastrointestinal diseases, behavorial disorders (CNS diseases), and diseases associated with changes in blood flow. There are no restrictions on the pathophysiologies that can be analyzed in accordance with the present invention in pharmaceutical research and development (e.g., analysis of drug potency, efficacy, toxicity, pharmacokinetics and pharmacodynamics).

The binding of a ligand (proteinaceous or nonproteinaceous (e.g., a nucleic acid)) to a binding partner (proteinaceous or nonproteinaceous (e.g., a nucleic acid)), where binding elicits a thermogenic response, can be monitored using electro thermometry. The ligand and/or binding partner can be in a cell or in a cell-free environment (e.g., a solution). The ligand and/or binding-partner can be a synthesized chemical entity that does not normally exist in nature, or the ligand and/or binding-partner can be a naturally occurring entity such as a naturally occurring protein, nucleic acid, polysaccharide, lipid, hormone, or other naturally occurring substance or cell. The effect of a test agent (e.g., potential ligand) on heat generated by its binding partner can be measured using electro thermometry.

One suitable method comprises: i) measuring the heat produced by the binding-partner, ii) adding test agent to the binding-partner, iii) measuring heat produced after mixing the potential ligand (test agent) and binding-partner, and iv) comparing the measurements in (i) and (iii), wherein an agent that alters heat generation is a ligand for the binding partner. Additionally, test agents can be screened for their ability to alter the thermogenic response resulting from the binding of the ligand to its binding-partner. Such agents can be allosteric regulators, agonists, or antagonists of the ligand and/or binding partner. Such a screen can comprise: i) measuring the heat produced upon addition of the first member of the binding pair (ligand or binding-partner) to the second member of the binding-pair using electro thermometry, and ii) measuring the heat produced upon addition of the first member of the binding pair, the second member of the binding-pair and test agent, and iii) comparing the measurement in (i) with that in (ii), wherein an agent that alters the heat generation observed upon addition of the ligand to its binding partner is a modulator of that interaction, for example, by binding to either or both members of the binding pair.

Agents can be screened for their ability to modulate the rate of catalysis of a particular enzyme. The method can comprise measuring the heat produced upon addition of an enzyme to its substrate using electro thermometry and measuring the heat produced upon addition of a test agent, the enzyme, and its substrate, and comparing the results. An agent that alters heat production can be an enzyme inhibitor or activator. Controls that can be run in accordance with such a method include measuring the heat produced upon addition of the enzyme to the test compound (in the absence of substrate) and upon addition of the substrate to the test compound (in the absence of the enzyme). Such controls permit determination of the effects on heat production from the respective additions. Using such an approach, test agents can be screened for their ability to behave as substrates. Such agents can increase heat production when mixed with enzyme in the absence of any other known substrate. In another embodiment, the present invention relates to a method of monitoring drug-drug interactions in various cells (humans, animals, plants). The method comprises: i) measuring the heat produced by the cells, using electro thermometry, before exposure to the agent(s), ii) exposing the cells to a single agent and to multiple agents (e.g., by adding to culture medium), iii) measuring the heat produced by the cells after treatment with a single agent and after treatment with multiple agents, using electro thermometry, iv) determining the differences in heat produced in steps (i) and (iii) and comparing the differences in heat produced after exposure to single agents with the heat produced after exposure to combined agents. A difference in the heat produced after exposure to multiple agents (as opposed to single agents) indicates that the agents interact or are eliciting a thermogenic response.

As indicated above, agents that result in a change in thermogenesis when used in combination, relative to when used singly, are proposed to be involved in pharmcodynamic drug-drug interactions. Such interactions can be potentially toxic or beneficial to the organism, tissue, or cells. As such, electro thermometry can be used to identify, predict, characterize, rank, and/or select how different agents (e.g., drugs) interact with each other. There are no restrictions to the type and number of agents or cells that can be used. The agents can be naturally occurring, synthetic, agonists, antagonists, inhibitors, activators, safe, toxic, anabolic, catabolic, known, or unknown. The cells, tissues, and organism can be derived from plants, animals (e.g., man), fungi, protozoans, or monera. Electro thermometry can be used to measure the heat produced by cells upon changing various pharmacokinetic and pharmacodynamic parameters, including altering the duration of exposure, the concentration of agent(s), pharmaceutical compositions, and number of agents used.

In another embodiment, the present invention relates to a method of evaluating safety profiles of pharmacologic agents. In accordance with this embodiment, various proteins (e.g., cytochrome P450s etc.), organelles (e.g., microsomes, etc.), cells targeted by an agent can be isolated, treated with varying concentrations of the agent and heat production monitored using electro thermometry. This method can comprise: i) determining the potency and efficacy of an agent on stimulating or inhibiting heat production in the desired target (e.g., a protein, organelle, cell, involved in the therapeutic effect of an agent), ii) determining the potency and efficacy of an agent on stimulating or inhibiting heat production in an undesirable target (e.g., a protein, organelle, cell, tissue involved in a toxic effect of an agent), iii) determining the selectivity of the agent by comparing the potency and efficacy in steps (i) and (ii).

Pharmacological agents that show increased selectivity between the various targets (e.g., protein, organelle, cell, tissue, and/or organ), can be expected to have improved safety profiles. Consistent with this embodiment, the effects of varying the concentration of the test agent on heat generated by binding-partners and/or enzyme catalysis can be used to evaluate the selectivity and safety profile against multiple targets. Optimum selectivity between desirable and undesirable targets (e.g., cell types, binding-partners, or enzymes) can be determined readily by one skilled in the art.

In one aspect, step (iii) comprises measuring the temperature of the sample resulting from step (ii) at a multiplicity of time points, step (iv) comprises comparing the temperature obtained in step (i) with the temperature obtained in step (iii) at each of the time points, wherein a difference in temperature between that obtained in step (i) and that obtained in step (iii) at least one of the time points indicates that the test agent caused a thermodynamic change in the sample.

Preferably, the cells are engineered to contain a heterologous nucleic acid sequence.

According to a further aspect of the present invention there is provided a method of screening a test agent for its ability to cause a thermodynamic change in a sample comprising the steps of:

(i) measuring the temperature of a sample or portion thereof;

(ii) contacting the sample or portion thereof, with the test agent,

(iii) measuring the temperature of the sample or portion thereof resulting from step (ii);

(iv) repeating steps (i)-(iii) at least once; and

(v) comparing the temperature obtained in step (i) with the temperatures obtained in steps (iii),

wherein temperature measurement steps (i) and (iii) are conducted using a non-invasive electro thermometric method.

A difference in temperature between that obtained in step (i) and that obtained in steps (iii) indicates that the test agent causes a thermodynamic change in the sample.

Suitably, the sample is a cell-free sample. In one aspect, the sample is a cell-containing sample.

Suitably, the cells present in the sample are eucaryotic cells. In one aspect, the cells are mammalian cells (e.g. tumor cells or adipocytes).

Suitably, the cells are plant cells. In another aspect, the cells are procaryotic cells.

In a further aspect, the cells are engineered to contain a nucleic acid sequence encoding a heterologous protein or engineered to overexpress a protein endogenous to the cells.

Preferably, the measuring of steps (i) and (iii) is effected using a resistance thermometer. More preferably, the thermometer comprises a platinum 1000 or a platinum 100 resistor.

In one aspect, the cells are engineered to contain a heterologous nucleic acid sequence.

According to a further aspect of the present invention, there is provided a method of screening a multiplicity of test agents for their ability to cause a thermodynamic change in a sample comprising:

(i) measuring the temperature of a sample or portion thereof;

(ii) contacting the sample, or portion thereof, with the test agent;

(iii) measuring the temperature of the sample or portion thereof resulting from step (ii);

(iv) repeating steps (ii)-(iii) using a multiplicity of different test agents, individually; and

(v) comparing the temperature obtained in step (i) with the temperatures obtained in steps (iii),

wherein temperature measurement steps (i) and (iii) are conducted using a non-invasive electro thermometric method.

A difference in temperature resulting from the addition of one of the test compounds to the sample or portion thereof indicates that one of the test agents causes a thermodynamic change in the sample.

In one aspect, the sample is a cell-free sample.

In another aspect, the sample is a cell-containing sample. Preferably, the cells present in the sample are eucaryotic cells. More preferably, the cells are mammalian cells (e.g. tumour cells or adipocytes).

Optionally, the cells are plant cells.

In one aspect, the cells are procaryotic cells.

Suitably, the cells are engineered to contain a nucleic acid sequence encoding a heterologous protein or engineered to overexpress a protein endogenous to the cells.

Preferably, the measuring of steps (i) and (iii) is effected using a resistance thermometer. More preferably, the thermometer comprises a platinum 1000 or a platinum 100 resistor.

In another aspect, the cells are engineered to contain a heterologous nucleic acid.

According to a further aspect of the present invention, there is provided a method of monitoring the physical state of a compound or composition comprising measuring the temperature of the compound or composition over time using a non-invasive electro thermometric method.

In accordance with this embodiment, the physical state of a compound can be determined using this method as it relates to a compound changing its physical properties of going from a solid (i.e. frozen liquid) to a liquid (i.e. melting), a liquid into a solid (i.e. crystallization), a liquid into a gas (i.e. evaporation, vaporization), a solid into a gas (i.e. sublimation). This embodiment can be applied but is not limited to compounds in open vessels, closed systems, pressurized vessels (i.e. inhalants). The amount of a liquid can be measured using the present invention. Consistent with this embodiment, each varying amount of the test agent generates a unique heat profile whereby the amount of agent present can be measured by its unique heat characteristics.

In one aspect, the monitoring is effected as the compound or composition is changing from a gas to a liquid, or vice versa, from a liquid to a solid, or vice versa, or from a solid to a gas, or vice versa.

The method herein may also be applied to multi-phase systems e.g. gas/solid; gas/liquid; and liquid/solid systems.

In a further aspect of the present invention there is provided a method of determining the amount of a compound or composition present in a container comprising measuring the temperature of said compound or composition present in said container using a non-invasive electro thermometric method.

In one aspect, the compound or composition is a liquid.

Suitably, the container is a multi-well microtitre plate.

According to another aspect of the present invention, there is provided a method of determining the thermogenic effect of a test agent on a sample comprising:

i) contacting the sample, or portion thereof, with a first amount of the agent and measuring the resulting temperature; and

ii) repeating step (i) at least once using a second, different, amount of the agent,

wherein temperature measurement step (i) is conducted using a non-invasive electro thermometric method.

A test agent that results in a thermogenic change in the sample at least of the amounts is an agent that exerts a thermogenic effect on the sample.

In one aspect, the sample is a cell-free sample.

In another aspect, the sample is a cell-containing sample.

According to another aspect of the present invention, there is provided a method of determining the thermogenic effect of a test agent on a sample comprising contacting the sample, or portion thereof, with the test agent and measuring the resulting temperature at a multiplicity of time points using a non-invasive electro thermometric method, wherein a test agent that causes a thermogenic change in the sample at least one of said time points is an agent that exerts a thermogenic effect on the sample.

Preferably, the sample is a cell free sample.

More preferably, the sample is a cell-containing sample.

In another embodiment, the present invention relates to a method of monitoring temperature in various organisms (animals, plants, tissues, and cells). Temperature is often indicative of a physiological or biological effect caused by a drug or other active agent, and can be measured by a suitably attached thermoelectric sensor. Attachment includes direct attachment through bonding, or holding by a suitable means against the surface, for example by an appropriate clip.

In one aspect, the method comprises: i) measuring heat produced either by an organism, using one or more thermoelectric sensors, under different environmental conditions (e.g., fed different diets: high or low fat, protein, or carbohydrate diets) or by organisms with different genetic backgrounds (e.g., inbred animals, populations), ii) exposing the organism(s) to various agents singly or multiply (e.g., placebos or thermogenic agents; including untreated controls), iii) measuring the heat produced by the organism(s) after treatment with the agent using one or more thermoelectric sensors, iv) comparing the measurements in steps (i) and (iii), to determine the influence of environmental changes and genetic background.

According to a further aspect of the present invention, there is provided a screening apparatus comprising a container for receipt of a sample; and an electro thermometer associated with the container for measuring the temperature of the sample, wherein in use, the electro thermometer does not contact the sample.

In aspects, the container (e.g. a well plate) is coated with one or more coating materials. Suitable coating materials include polymeric materials such as silicones, acrylics or epoxy. The coating is typically applied by brushing, dipping or spraying. Typical coatings are of the order of a few tens of microns thick (e.g. from 10 to 90 microns).

In one measurement aspect, a differential arrangement of two electro thermometric (e.g. resistance thermometer) devices is used to measure the temperature difference between two wells of a well plate, or alternatively between one well and ambient. Several types of arrangements are envisaged including those comprising a bridge; a ratiometric signal where one resistance thermometer supplies a reference voltage or current and a second resistance thermometer provides the signal; and the use of two separate resistance thermometric measurements followed by a subtraction of the readings.

Bandwidth narrowing techniques may be employed to improve the signal to noise ratio of the detected electro thermometric signal. In one aspect, a resistance thermometer is driven by an AC source and a phase-sensitive amplifier is used to detect the signal.

Various power saving and energy efficiency improvement techniques may be employed. In one aspect, a pulsed, low duty cycle drive is provided to the electro thermometer only while a measurement is being recorded in order to reduce self-heating and to extend the battery life of a self contained power unit.

In one aspect, the power is supplied via a high frequency transformer (e.g. of the type used in cordless chargers). In variations, a first high frequency transformer is built into suitable robotics aspects of the apparatus and a second high frequency transformer is positioned on a well plate.

Suitably, the screening apparatus communicates with an electronic data management system for receiving resistance data from the electro thermometric sensor. The electronic data management system is typically enabled to process, analyse and display said data (e.g. via a suitable user interface).

Suitably, the screening apparatus is additionally provided with telemetry capability, that is to say it comprises a communicator for wireless communication with a network computer system to enable transfer of data between the network computer system and the electronic data management system. Preferably, the communicator enables two-way transfer of data between the network computer system and the electronic data management system.

Suitably, the data is communicable between the network computer system and the electronic data management system in encrypted form. All suitable methods of encryption or partial encryption are envisaged. Password protection may also be employed. Suitably, the communicator employs radio frequency or optical signals.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radio frequency signals. A suitable spread spectrum protocol is the Bluetooth (trade mark) standard which employs rapid (e.g. 1600 times a second) hopping between plural frequencies (e.g. 79 different frequencies). The protocol may further employ multiple sending of data bits (e.g. sending in triplicate) to reduce interference.

In one aspect, the network computer system comprises a public access network computer system. The Internet is one suitable example of a public access network computer system, wherein the point of access thereto can be any suitable entry point including an entry point managed by an Internet service provider. The public access network computer system may also form part of a telecommunications system, which may itself be either a traditional copper wire system, a cellular system or an optical network.

In another aspect, the network computer system comprises a private access network computer system. The private access network system may for example, comprise an Intranet or Extranet. The network may for example include password protection; a firewall; and suitable encryption means.

Preferably, the communicator enables communication with a user-specific network address in the network computer system.

The user-specific network address may be selected from the group consisting of a web-site address, an e-mail address and a file transfer protocol address. Preferably, the user-specific network address is accessible to a remote information source such that information from said remote information source can be made available thereto. More preferably, information from the user-specific network address can be made available to the remote information source.

Embodiments are envisaged in which the apparatus comprises plural containers, each associated with an electro thermometer for measuring the temperature of a sample contained therewithin.

In aspects, the container is selected from the group consisting of petri dish, test tube and microtitre dish.

Objects and advantages of the present invention will be clear from the description that follows.

### BRIEF DESCRIPTION OF THE DRAWINGS

FIG. 1. is a schematic plan view of a microtitre plate.

FIG. 2. is a detailed underview of a microtitre plate with a platinum resistor connected to the base of the plate.

FIG. 3. is a schematic sectional view of a microtitre plate positioned upon a thermal plate reader.

FIG. 4. is a schematic sectional view of a carrier plate supporting wells in contact with a resistance thermometer.

FIG. 5. is a diagram of a printed circuit board with resistance thermometers attached in accordance with the present invention.

FIG. 6. is a graph comparing the thermal sensitivity of infra-red thermal imaging and electro thermometry.

FIG. 7a depicts the thermal sensitivity of electro thermometry in monitoring the addition of a 5 μl aliquot of water to 100 μl of 10% ethanol solution.

FIG. 7b shows the thermal sensitivity of electro thermometry in monitoring the addition of water of a 5 μl aliquot of water to 100 μl of 3.3% ethanol solution.

FIG. 7c gives the thermal sensitivity of electro thermometry in monitoring the addition of a 5 μl aliquot of water to 100 μl water.

FIG. 8 shows a circuit diagram for a sampling array of sensors.

FIG. 9 shows a circuit diagram for a sampling array of sensors.

FIG. 10 shows a system diagram for an electro thermometric monitoring system herein.

### DETAILED DESCRIPTION OF THE INVENTION

Platinum resistance thermometers (PRTs) offer high accuracy over a wide temperature range. Sensors are available from many manufacturers with various accuracy specifications and numerous packaging options. The sensors used in the present invention are surface mounted units, selected for their small size and low heat capacity. Platinum 100 or 1000 surface mount resistance thermometers are particularly suitable for use with microtitre plates, which are widely used for chemical and biochemical screening purposes in the chemical and pharmaceutical industries.

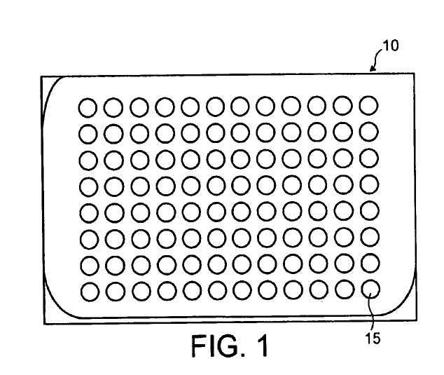

Microtitre plates come in a variety of formats (typically 24, 48, 96, 384, 1536 and 6144 well formats) and consist of flat, plastic plates comprising a number of wells in which test reagents, such as chemicals and/or biological materials, are allowed to react. These microtitre plates are commonly used in automated assays for high-throughput screening, chemical and biological reactions being typically monitored by calorimetric or fluorescent means. FIG. 1 is a plan view of a typical microtitre plate 10 showing the 96 wells 15 arranged in a 12×8 format.

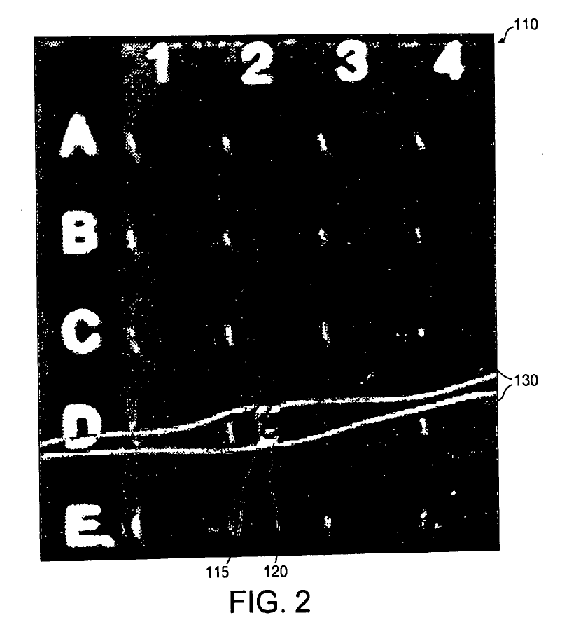

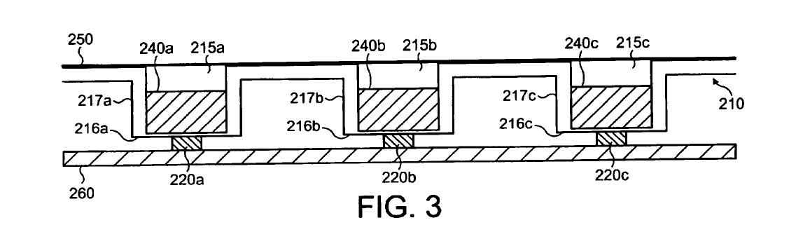

FIG. 2 shows a portion of a similar 96 well microtitre plate 110 with a Pt1000 resistor 120 surface mounted to the base of well D2 (115) and connected to a monitoring device (not shown) by conductive wires 130. Any reaction in a microtitre plate that results in a measurable change in temperature in the reaction media within the well 115 can be detected by the platinum resistor 120. A sectional perspective of a schematic representation of an embodiment of the present invention is shown in FIG. 3. Wells 215a-c of microtitre plate 210 are partially filled with chemical reactants 240a-c and covered with a thin rubber septum 250. The reactants are stirred or agitated by conventional means (e.g. magnetic stirrer) to ensure thorough mixing to facilitate any chemical reactions. The septum 250 prevents evaporation of the reactants which can be injected through it (for example, to initiate the reaction). The plate 210 is generally of a disposable nature to avoid contamination by chemical or biological reactants and is composed of a polymer. As can be seen from FIG. 3, the bases 216a-c of the wells 215a-c are extremely thin in comparison to the walls 217a-c to maximise thermal conductivity to the platinum resistors 220a-c. The thickness of the bases 216a-c are typically in the range 5-100 μm. In an alternative embodiments (not shown), the composition of the bases 216a-c may comprise other materials with extremely high thermal diffusivity, but poor electrical conductivity, including those which offer a balance of these desired characteristics. As will be understood, these microtitre plates must be specifically manufactured for use in the assay in order that the base of the wells maximise thermal conductivity. This may be achieved by removal of existing bases from standard microtitre plates and replacement with bases of appropriate thickness and/or composition.

Platinum resistors 220a-c are positioned against the bases 216a-c of the wells 215a-c and are connected to a printed circuit board 250. Any change in temperature of the reactants within the wells 215a-c will be detected by the platinum resistors 220 a-c and relayed through the printed circuit board 260 to a data recorder (not shown).

In aspects herein, the wells 215a-c are provided with a septum to insulate the contents from the environment and thus reduce heat losses due to evaporation. The septum allows reagent to be injected into the wells. This aids sensitivity of monitoring.

The method is typically conducted in a carefully controlled environment to maximise thermal stability and minimise environmental effects. In particular, the apparatus is suitably enclosed in an environmental chamber. Optionally, a stirrer may stir the reactive media.

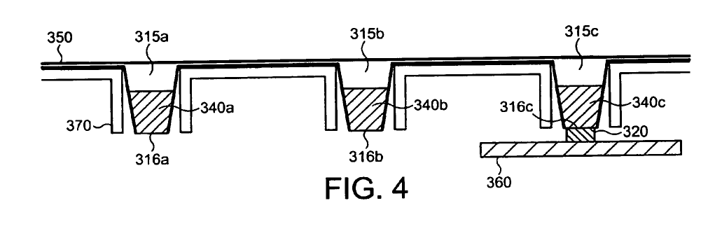

An alternative embodiment of the invention is depicted in FIG. 4. This sectional view shows a carrier plate 370 with well inserts 315a-c contacting a platinum resistor 320 connected to a printed circuit board 360. Whilst for clarity, the platinum resistor 320 and printed circuit board 360 are only illustrated are contacting one well insert 315c, it will be appreciated that such elements are present for all well inserts 315a-c of the plate 370. In embodiments, the well inserts 315a-c may either be standalone (i.e. separate) or in the form of an array to fit into the carrier plate 370. The well inserts are typically formed by injection moulding and have thin bases, as before. The carrier plate 370 is designed to support the well inserts 315a-c at a position to achieve an optimal thermal contact between the well base 316a-c and the platinum resistor 320 (only one illustrated). It will be understood that each well base 316a-c would be in contact with a resistor 320 in order to separately monitor temperature changes occurring within each reactant mixture 340a-c. The base of the wells must be composed of a material of high thermal diffusivity which is compatible with the chemical components of the sample, and should be of a thickness (e.g. in the range 5-100 μm) to maximise thermal conductivity. As in the previous Figure, a thin rubber septum 350 is positioned above each well 315 in order to prevent evaporation.

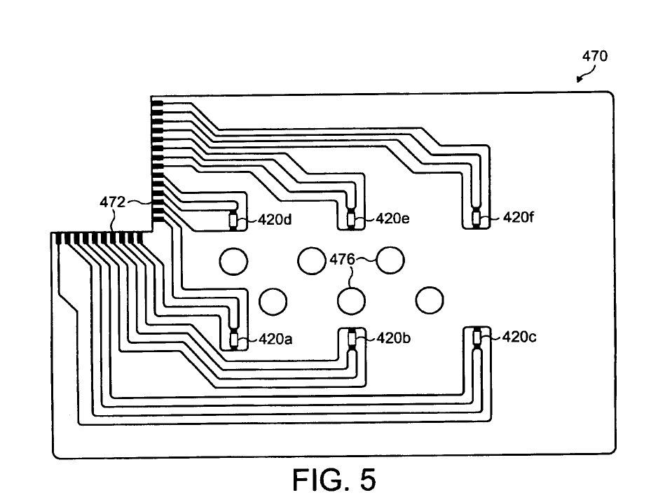

FIG. 5 illustrates the layout of a printed circuit board 470 for the thermal plate reader. Connectors 472 allow communication with a temperature recording device (not shown). The platinum resistors 420a-f are positioned for optimal contact with the base of microtitre wells (not shown) and communicate with connectors 472 via conductive wires 474. In the circuit board illustrated, holes 476 have been cut in the base to facilitate thermal reading by an infrared camera to allow comparative studies (see below). In this embodiment only 6 of the 96 well positions have associated resistors, but versions having all 96 positions with associated resistors are envisaged.

In aspects, the printed circuit board 360, 360, 460 of FIGS. 3 to 5 is arranged to have a flexible rather than rigid form to aid physical compliance, and hence thermal contact, with the wells of the well plate. In other aspects, the platinum resistors are encapsulated under a layer of such a flexible printed circuit board or alternatively, suitable resistance elements may be evaporated, printed or sputtered onto the printed circuit board. In still further aspects, heating and/or cooling elements may be incorporated on the printed circuit board or other support. The platinum resistor itself, may indeed be used as a heating element.

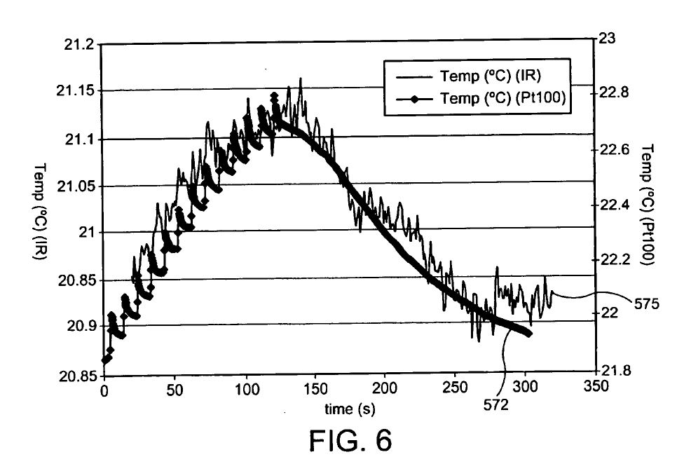

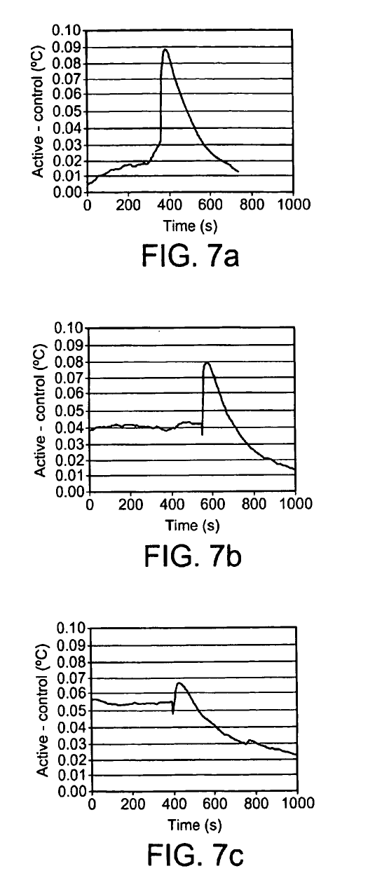

An example of an output from the system is given in FIG. 6, which compares temperature sensitivity using the infrared camera monitoring system (such as that disclosed in WO 99/60630) to a platinum 100 resistor system. Light was pulsed from a 6 volt, 300 mA bulb every 10 seconds for 120 second period onto a 100 μl sample of water contained in a well insert made from polythene-based polymer with a thin base. As can be seen, the sensitivity of the platinum resistors (line 572) in terms of detecting temperature change (scale is 0.2° C. per division) is very similar to that of the infrared imaging technique (line 575). A similar system to that described above, but using two Platinum 1000 resistors, was used to measure temperature change occurring in a set of alcohol dilution assays in two wells of a microtitre plate (FIGS. 7a-c). Resistance measurements were made by an Agilent 34970A meter, set to measure resistance in 4 wire mode at 1 Kohm resistance and 6.5 digit resolution. Aliquots (5 μl) of pure water (HPLC grade) were added to 100 μl of solutions of ethanol (95% pure, laboratory reagent grade) in water at concentrations of 10% (FIG. 7a) and 3.3% (FIG. 7b). The reference standard (FIG. 7c) was an identical sample but without the addition of water. As expected, a greater thermal response is seen on adding water to the more concentrated alcohol solution (FIG. 7a) than the dilute solution (FIG. 7b). The ‘response’ in the reference sample, where the 5 μl aliquot of water is added to pure water, is due to the high sensitivity of the system—the approach of an empty pipette being sufficient to cause a significant temperature increase (FIG. 7c). As can be seen from FIGS. 7a-c, the thermal sensitivity or resolution of the system is in the order of a few mK.

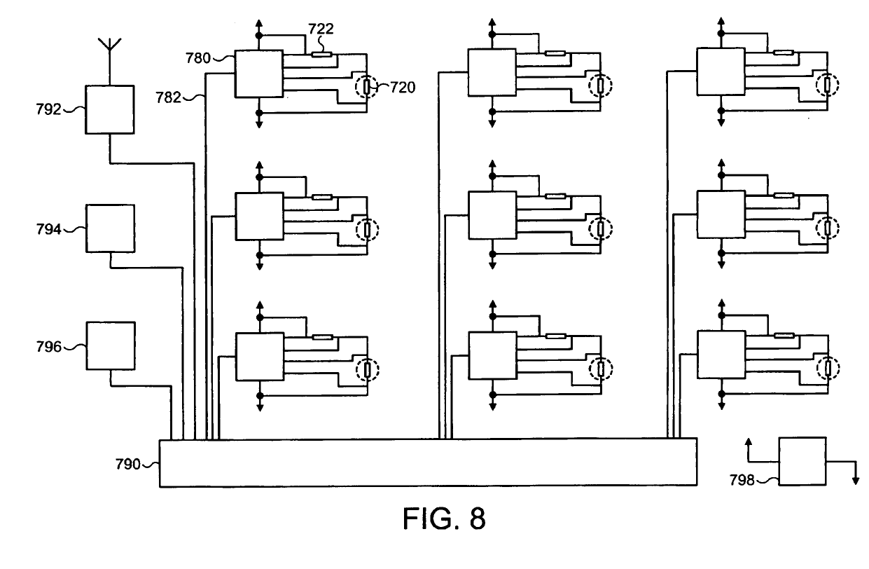

FIG. 8 shows a circuit diagram for sampling array of sensors. As shown, only one element of the array is labelled in detail: each other element comprises similar features. In more detail, resistance temperature sensor 720 is in a circuit with reference resistor 722 and analogue to digital converter 780. The circuit communicates with microcontroller 790 via interface 782. The microcontroller also communicates with radiofrequency communication interface 792; optical communication interface 794; and wired communication interface 796 to enable ready communication of data (e.g. to a networked computer system). The whole system is powered by power supply 798.

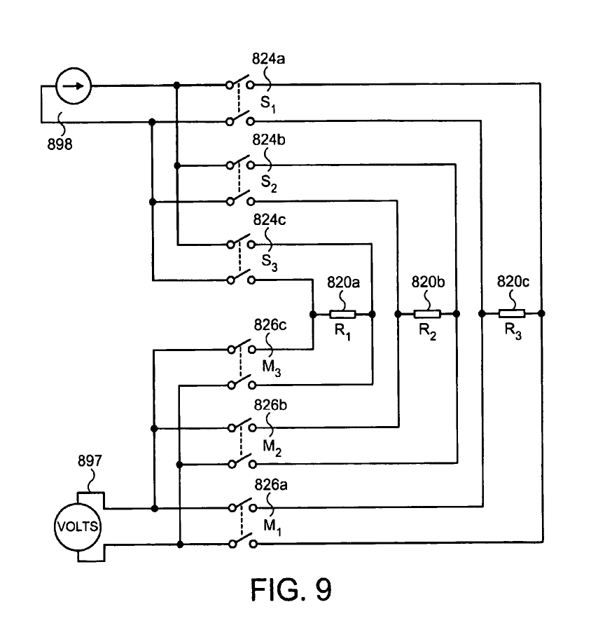

FIG. 9 shows a circuit diagram for an array of sensors herein. For simplicity, only three sensors are illustrated. In more detail, resistors R₁, R₂ and R₃ 820a-c are connected through circuitry to respective source relays S₁, S₂ and S₃ 824a-c and measurement relays M₁, M₂ and M₃ 826a-c, and to current source 898 and voltmeter 897. When making resistance measurements, the source relays S₁, S₂ and S₃ 824a-c are paired with the measurement relays M₁, M₂ and M₃ 826a-c. For example, relay S₁ 824a is closed and a constant current flows through resistor R₁ 820a. Relay M₁ 826a is also closed and the voltage across R₁ 820a is measured by the voltmeter. The resistance of R₁ 820a is determined from the current and voltage. The temperature is determined from the resistance using a lookup table or calibration curve.

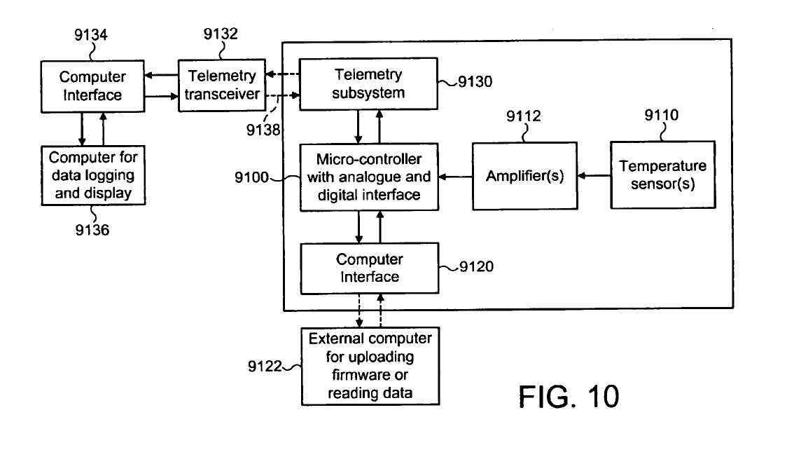

FIG. 10 shows a simplified system diagram for an electro thermometric monitoring system for a well plate or other monitoring apparatus herein, which includes wireless telemetry capability. The advantage of such a configuration is that the plate may be located separate from, but in wireless contact with, a data display and user-interface system.

Micro-controller 9100, which is provided with analogue and digital interface, acts as the control hub for the various components of the system. Temperature sensor(s) 9110 supply temperature data via amplifier 9112 to the micro-controller 9100. The data is transferable for further processing at computer interface 9120, which in turn connects to an external computer 9122 arranged for uploading firmware or reading data. The micro-controller 9100 further interacts with telemetry subsystem 9130 comprising optical, radio frequency or inductive elements for wireless transfer of data. The telemetry subsystem in turn, connects to telemetry transceiver 9132, computer interface 9134 and further computer 9136 for data logging and display. It will be appreciated that the wireless telemetric communications link 9138 means that the transceiver 9132, computer interface 9134 and further computer 9136 may be located distant from the rest of the monitoring system.

It will be understood that the present disclosure is for the purpose of illustration only and the invention extends to modifications, variations and improvements thereto.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A screening apparatus for use in monitoring temperature changes in chemical and biochemical reactions comprising:
a well-plate defining an array of wells, each well arranged for receipt of a sample; and
an electro thermometer associated with at least one well of said well-plate for measuring the temperature of a sample received by said at least one well such that in use, the electro thermometer does not contact the received sample,
wherein the electro thermometer comprises a platinum resistance thermometer.

2. The screening apparatus according to claim 1, wherein said platinum resistance thermometer comprises a Pt100 platinum resistor that has a resistance of 100 ohms at a temperature of 0° C.

3. The screening apparatus according to claim 1, wherein said platinum resistance thermometer comprises a Pt1000 platinum resistor that has a resistance of 1000 ohms at a temperature of 0° C.

4. The screening apparatus according to claim 1, in which a platinum resistance thermometer is associated with each well of said well-plate.

5. The screening apparatus according to claim 4, in which a platinum resistance thermometer is associated with the base of each well of the well-plate.

6. The screening apparatus according to claim 1, wherein the well-plate comprises a coating of one or more coating materials selected from the group consisting of silicones, acrylics and epoxy.

7. The screening apparatus according to claim 6, wherein said coating has a thickness of from 10 to 90 microns.

8. The screening apparatus according to claim 1, wherein at least one well of the well-plate is provided with a well insert.

9. The screening apparatus according to any claim 1, additionally comprising a cover for the well-plate for covering said array of wells.

10. The screening apparatus of claim 9, wherein said cover comprises a septum that allows injection of material into the wells.

11. The screening apparatus according to claim 4, in which the electro thermometer comprises an array of platinum resistance thermometers registrable with the array of wells of the well-plate.

12. The screening apparatus of claim 11, wherein said array of platinum resistance thermometers connects to a printed circuit board.

13. The screening apparatus of claim 1, adapted to communicate with an electronic data management system for receiving electro thermometric data from the electro thermometer.

14. The screening apparatus according to claim 13, additionally comprising a communicator for wireless communication with a network computer system to enable transfer of the data between the network computer system and the electronic data management system.

15. A screening system comprising the screening apparatus according to claim 1; and in communication therewith, an electronic data management system for receiving electro thermometric data from the electro thermometer.

16. The screening system according to claim 15, wherein the electronic data management system is enabled to process and display said data.

17. A method of use of the screening apparatus according to claim 1 for screening a test agent for its ability to cause a thermodynamic change in a sample, comprising the steps of:
(i) placing a sample in at least one well of the well-plate;
(ii) measuring the temperature of said sample;
(iii) contacting the sample with said test agent;
(iv) measuring the temperature of the sample resulting from step (iii); and
(v) comparing the temperature obtained in step (ii) with the temperature obtained in step (iv);
wherein temperature measurement steps (ii) and (iv) are conducted using the electro thermometer.

18. The method according to claim 17, wherein the sample comprises an organic or an inorganic compound.

19. The method according to claim 18, wherein said organic compound is selected from the group consisting of protein, carbohydrate, lipid or nucleic acid.

20. The method according to claim 19, in which the test agent binds said organic compound and a thermodynamic change in the sample thereby results.

21. The method according to claim 17, wherein step (iv) comprises measuring said temperature of said sample resulting from step (iii) at a multiplicity of time points, step (v) comprises comparing the temperature obtained in step (ii) with the temperature obtained in step (iv) at each of said time points, wherein a difference in temperature between that obtained in step (ii) and that obtained in step (iv) at least one of said time points indicates that said test agent causes a thermodynamic change in said sample.

22. Method according to claim 17, for screening a test agent for its ability to cause a thermodynamic change in a sample of cells.

23. Method according to claim 22, wherein said cells are selected from the group consisting of cultured cells, eucaryotic cells, mammalian cells, tumour cells, adipocytes, plant cells, procaryotic cells, cells engineered to contain a heterologous nucleic acid sequence and cells engineered to contain a nucleic acid sequence encoding a heterologous protein or engineered to overexpress a protein endogenous to said cells.

24. Method according to claim 17, in which steps (iii) and (iv) are repeated using a multiplicity of different test agents, individually.
